(19) United States
(12) Patent Application Publication
(10) Pub. No.: US 2026/0104083 A1
(43) Pub. Date: Apr. 16, 2026

(54) SOLENOID VALVE ASSEMBLY

(71) Applicant: HL MANDO CORPORATION, Pyeongtaek (KR)

(72) Inventors: Kyudo KIM, Pyeongtaek (KR); Eunjoong KIM, Pyeongtaek (KR)

(21) Appl. No.: 19/267,998

(22) Filed: Jul. 14, 2025

(30) Foreign Application Priority Data
Oct. 16, 2024 (KR) 10-2024-0141092

(51) Int. Cl. F16F 9/46

(52) U.S. Cl. CPC F16F 9/465; F16F 2236/04

(57) ABSTRACT

An embodiment of the present disclosure relates to a solenoid valve assembly. The solenoid valve assembly according to an embodiment of the present disclosure includes: a coupling unit coupled to the cylinder; a solenoid coil; and a solenoid coil guide coupled to the coupling unit and into which at least a portion of the solenoid coil is inserted, wherein the solenoid coil is coupled to the solenoid coil guide in a direction-specific manner, and at least a portion of the solenoid coil guide is formed of plastic.

### CROSS-REFERENCE TO RELATED APPLICATION

This application claims the benefit of and priority to Korean Patent Application No. 10-2024-0141092, filed on October 16, 2024, the entire disclosure(s) of which is hereby incorporated herein by reference in its entirety.

### TECHNICAL FIELD

The present disclosure relates to a solenoid valve assembly. More specifically, the present disclosure relates to a solenoid valve assembly mounted on a shock absorber.

### BACKGROUND

The description in this section merely provides background information related to the present disclosure and does not constitute the related art.

During driving, a car is constantly exposed to vibrations or shocks from the road surface through wheels. When the vibrations or shocks transmitted through the wheels are directly transmitted to a car body and steering wheel, the ride quality and driving stability are significantly reduced. In order to alleviate such vibrations or shocks, a car needs to be equipped with a suspension system. Shock absorbers, springs, and suspension arms are the main components of the suspension system.

A shock absorber is configured of a cylinder, a piston rod, and a piston valve. The piston valve is located inside the cylinder while coupled to the piston rod and generates damping force.

When the damping force of the shock absorber is set to a weak level, a car absorbs vibrations caused by uneven road surfaces, thereby improving ride quality. On the other hand, when the damping force is set to a high level, the posture change of a car body is suppressed, which improves handling stability. Accordingly, in the past, it was common to select and apply shock absorbers with different damping force characteristics set depending on the purpose of use of a vehicle.

Recently, a variable damping force shock absorber has been developed that may adjust the damping force characteristics appropriately depending on the road surface and driving conditions by mounting a variable damping force valve that may adjust the damping force characteristics of the shock absorber appropriately.

For example, referring to FIG. 1, a variable damping force shock absorber having a dual solenoid valve structure equipped with a rebound solenoid valve 90 for adjusting the damping force during a rebound stroke and a compression solenoid valve 80 for adjusting the damping force during a compression stroke has been developed.

The interior of the cylinder configuring the shock absorber is divided into a compression chamber and a rebound chamber by a piston valve, and each chamber is filled with a fluid such as oil.

During the compression stroke, the piston valve pressurizes the fluid in the compression chamber, so that the compression chamber becomes high pressure, and the rebound chamber becomes relatively low pressure. During the rebound stroke, the piston valve pressurizes the fluid in the rebound chamber, so that the rebound chamber becomes high pressure, and the compression chamber becomes relatively low pressure.

Referring to FIGS. 2 to 5, the operating structure of the variable damping force shock absorber of the related art of Korean Patent Application Publication No. 10-2023-0068294 (Patent Document 1) having a dual solenoid valve structure will be reviewed.

During the compression stroke of FIGS. 2 and 3, the fluid in a compression chamber 13 flows into a compression separation tube 15 and moves to a reservoir chamber 17 through a compression solenoid valve 80, and some of the fluid moves to the rebound chamber 14 through a bypass flow path of a piston valve.

During the rebound stroke of FIGS. 4 and 5, the fluid in the rebound chamber 14 flows into a rebound separation tube 16, passes through a communication hole 103a of the rebound solenoid valve 90 and a connection unit 103, and moves into the compression chamber 13 through the compression solenoid valve 80, and some of the fluid moves into the compression chamber 13 through the bypass flow path of the piston valve.

FIG. 6 illustrates a solenoid coil valve of the shock absorber. Referring to FIG. 6, the variable damping force shock absorber has a solenoid valve for restricting the fluid from flowing from any one of the compression chamber, the rebound chamber, and the reservoir chamber to another chamber.

A solenoid coil of the solenoid valve is coupled to the cylinder via a solenoid coil guide coupled to an outer circumferential surface of the cylinder, and is coupled to the direction of the coil guide in a direction-specific manner (in an embodiment of the present disclosure, when a configuration is coupled to another configuration in a direction-specific manner, it means that the configuration is coupled only in a specific direction determined by the other element). Since the interior of the solenoid coil guide does not have an axially symmetrical shape, the solenoid coil guide may also have to be coupled in a specific direction with respect to the cylinder.

Because of the direction specificity of the solenoid coil and the solenoid coil guide, there is an issue in that in order to change the coupling direction of the solenoid coil, a new solenoid coil guide designed according to the coupling direction of the solenoid coil needs to be produced.

The solenoid coil guide is manufactured through forging of metal, and this also has the issue that the unit cost of the material and manufacturing process is high.

### SUMMARY

Accordingly, the present disclosure has been devised to obviate the above limitation of the related art. An aspect of the present disclosure is designed to reduce the cost of replacing a solenoid coil guide when changing the direction of a solenoid coil.

The aspects of the present disclosure are not limited to those mentioned above, and other aspects not mentioned herein will be clearly understood by those skilled in the art from the following description.

A solenoid valve assembly according to an embodiment of the present disclosure is mounted on a cylinder of a shock absorber, and includes: a coupling unit coupled to the cylinder; a solenoid coil; and a solenoid coil guide coupled to the coupling unit and into which at least a portion of the solenoid coil is inserted, wherein the solenoid coil is coupled to the solenoid coil guide in a direction-specific manner, and at least a portion of the solenoid coil guide is formed of plastic.

The solenoid coil guide is formed by an injection or casting method.

The coupling unit has a ring-shaped insertion unit that surrounds an outer circumferential surface of the cylinder formed therein.

The solenoid coil guide has a cylindrical shape with open upper and lower surfaces.

The solenoid coil guide has a longitudinally recessed and circumferentially extended settlement groove, and the solenoid coil is coupled to the solenoid coil guide with respect to the settlement groove in a direction-specific manner.

The coupling unit has at least one flat surface, and the coil guide is coupled to the flat surface.

The flat surface is disposed on an outer side of the cylinder in a radial direction.

The flat surface is disposed perpendicular to the radial direction of the cylinder.

The flat surface is disposed on an outer side in the radial direction from the cylinder.

The solenoid coil guides are included in a plural number.

The plurality of solenoid coil guides are disposed at the same height as one another.

The plurality of solenoid coil guides are disposed in parallel with one another.

The solenoid coil guides are included in a plural number, and the settlement grooves of the plurality of solenoid coil guides are formed in the same direction as one another.

The settlement groove is formed at a lower portion of the solenoid guide.

At least one of the plurality of solenoid coil guides is coupled with a compression solenoid valve that provides a flowing route of fluid during a compression stroke of the shock absorber.

At least one of the plurality of solenoid coil guides is coupled with a rebound solenoid valve that provides a flowing route of fluid during a tension stroke of the shock absorber.

A flow path is formed inside the coupling unit to communicate the solenoid valve and the inside of the cylinder.

A distance from the flat surface to a distal end of the solenoid coil guide is shorter than a distance from an outer circumferential surface of the cylinder to the flat surface.

The shock absorber of an embodiment of the present disclosure includes the solenoid valve assembly of an embodiment of the present disclosure.

A vehicle of an embodiment of the present disclosure includes a shock absorber having the solenoid valve assembly of an embodiment of the present disclosure.

According to an embodiment of the present disclosure, the cost of replacing the solenoid coil guide when changing the direction of the solenoid coil can be reduced.

### BRIEF DESCRIPTION OF THE DRAWINGS

FIG. 1 is a schematic diagram illustrating an electronically controlled shock absorber to which a conventional dual solenoid valve is applied.

FIGS. 2 and 3 are diagrams illustrating the flow of fluid during a compression stroke in an electronically controlled shock absorber to which a conventional dual solenoid valve is applied.

FIGS. 4 and 5 are diagrams illustrating the flow of fluid during a rebound stroke in an electronically controlled shock absorber to which a conventional dual solenoid valve is applied.

FIG. 6 is a diagram illustrating the configuration of a solenoid coil valve of a shock absorber.

FIG. 7 is a perspective view of a solenoid valve assembly coupled to a cylinder according to an embodiment of the present disclosure.

FIG. 8 is a perspective view of a shock absorber according to an embodiment of the present disclosure.

FIG. 9 is an exploded perspective view of a shock absorber according to an embodiment of the present disclosure.

FIG. 10 is a partial enlarged view of a solenoid valve unit according to an embodiment of the present disclosure.

FIG. 11 is an enlarged view of a rod guide according to an embodiment of the present disclosure.

FIG. 12 is a perspective view of a cap assembly according to an embodiment of the present disclosure.

FIG. 13 is a diagram illustrating a cylinder, a damping force adjustment assembly, and a cap assembly according to an embodiment of the present disclosure.

### DETAILED DESCRIPTION

Spatially relative terms, such as “below,” “beneath,” “lower,” “above,” “upper,” and the like, may be used for ease of description to describe a relationship between one component and another components as illustrated in the drawings. Spatially relative terms may be intended to encompass different orientations of the components in use or operation in addition to the orientation illustrated in the drawings. The component may also be oriented in a different orientation, and accordingly, the spatially relative terms may be interpreted according to the orientation.

Throughout the specification, when an element is referred to as being “connected” to another element, the element is “directly connected” to the other element, or “connected” to the other element with another intervening element interposed therebetween. It will be further understood that when an element “comprises” or “includes” a component, the element may further “comprise” or “include” another component, but do not preclude the presence of the other component, unless otherwise specifically stated.

An embodiment of the present disclosure relates to a solenoid valve assembly 100 mounted on a cylinder 1a of a shock absorber. The solenoid valve assembly 100 of an embodiment of the present disclosure includes a coupling unit 110 coupled to the cylinder 1a, a solenoid coil 12, and a solenoid coil guide 120 coupled to the coupling unit 110 and into which at least a portion of the solenoid coil 12 is inserted. The solenoid coil 12 is coupled to the solenoid coil 12 in a direction-specific manner. According to an embodiment of the present disclosure, since the coupling unit 110 is directly coupled to the cylinder 1a instead of the solenoid coil 12 and at least a portion of the solenoid coil guide 120 is formed of plastic, less cost is required to change the direction of the solenoid coil guide 120 compared to the conventional one.

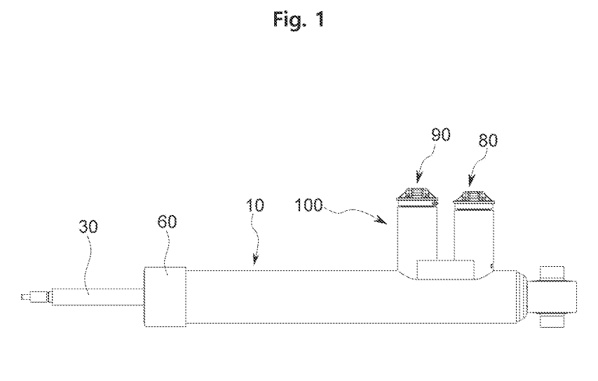

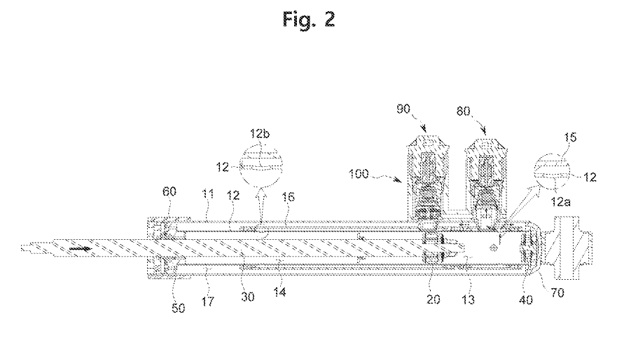

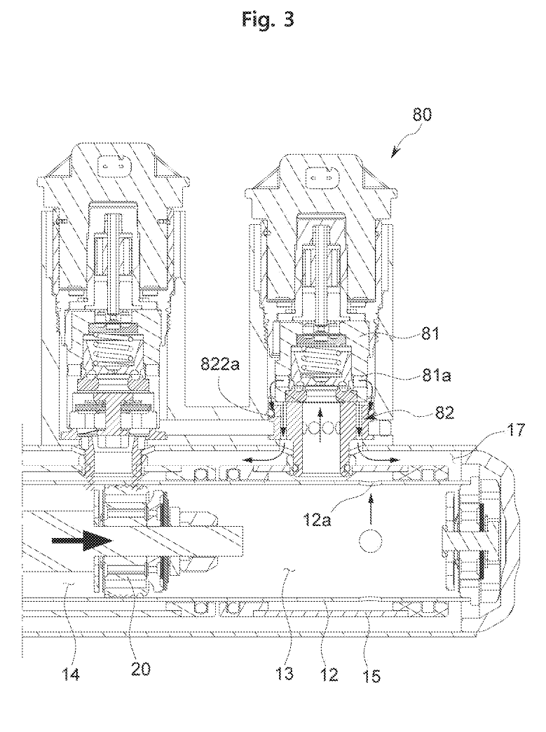

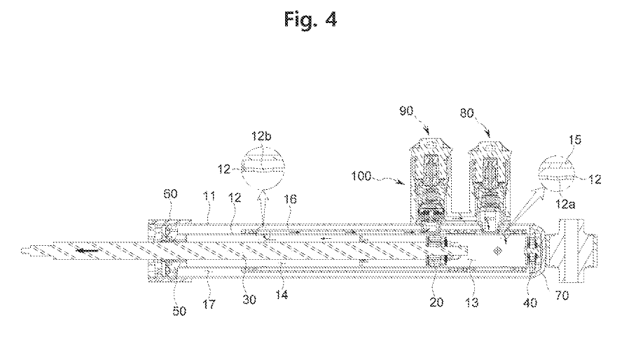

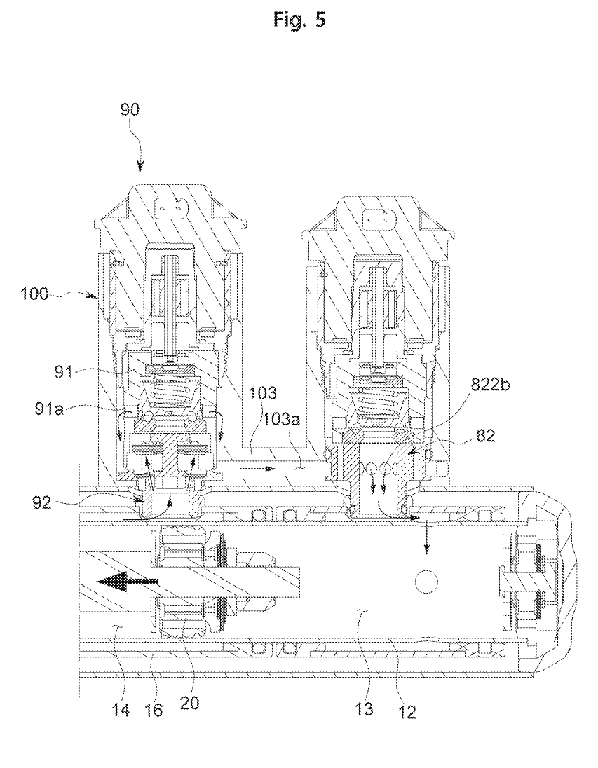

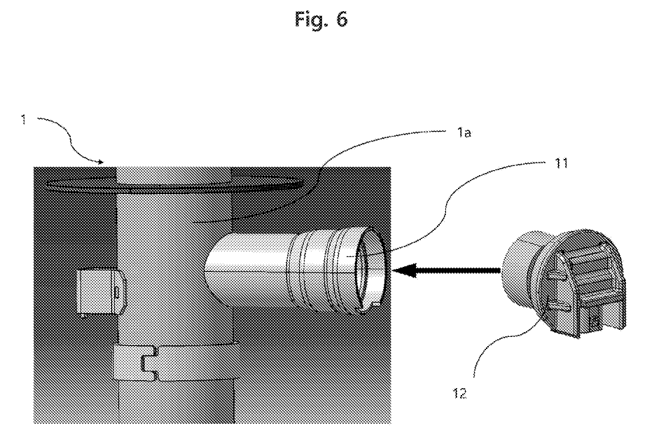

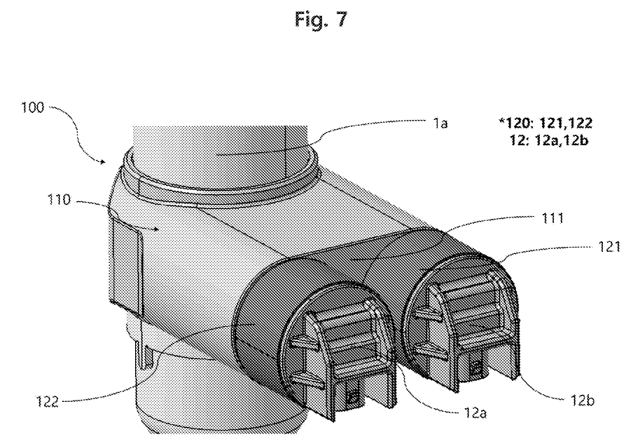

FIG. 7 is a perspective view of the solenoid valve assembly 100 (FIG. 7) coupled to the cylinder 1a according to an embodiment of the present disclosure. Hereinafter, the solenoid valve assembly 100 (FIG. 7) according to an embodiment of the present disclosure will be described with reference to FIG. 7. In FIG. 7, the same reference numerals as those of FIGS. 1 to 6 may refer to subject matters different from those referred to by the duplicated reference numerals of FIGS. 1 to 6. In the description referring to FIG. 7, the subject matters referred to by the reference numerals refer to FIG. 7, not FIGS. 1 to 6. Referring to FIG. 7, the solenoid valve assembly 100 of an embodiment of the present disclosure includes the coupling unit 110, the solenoid coil 12, and the solenoid coil guide 120.

The coupling unit 110 is coupled to the cylinder 1a. The coupling unit 110 may be directly coupled to the cylinder 1a. The coupling unit 110 has a ring-shaped insertion part that surrounds an outer circumferential surface of the cylinder 1a. The coupling unit 110 may completely surround an outer circumferential surface of a specific height of the cylinder 1a. The coupling unit 110 may have at least one flat surface 111. In an embodiment, the coupling unit 110 has a single flat surface 111. The solenoid coil guide 120 is coupled to the coupling unit 110. The solenoid coil guide 120 may be coupled to the flat surface 111. The flat surface may be disposed radially outside the cylinder 1a. The flat surface 111 may be disposed perpendicular to the radial direction of the cylinder 1a. The flat surface 111 may be disposed radially outside the cylinder 1a. Herein, the flat surface 111 being disposed on the radially outside of the cylinder 1a means that the cylinder 1a is not placed on a plane that includes the flat surface 111 when the flat surface is perpendicular to the radial direction of the cylinder 1a. The width of the flat surface 111 may be longer than the height.

The distance from the flat surface 111 to a distal end of the solenoid coil guide 120 may be shorter than the distance from an outer circumferential surface of the cylinder 1a to the flat surface 111. This is to minimize the size of the solenoid coil guide 120 with high replaceability, thereby reducing the replacement cost of the solenoid coil 12.

A flow path that communicates the solenoid valve and the inside of the cylinder 1a may be formed inside the coupling unit 110. Instead of the solenoid coil guide 120, such a flow path is formed inside the coupling unit 110, so that the coupling direction of the solenoid coil guide 120 may not be limited by the direction of the cylinder 1a.

The solenoid coil 12 is coupled to the solenoid coil guide 120 in a direction-specific manner. The solenoid coil guide 120 is coupled to the coupling unit 110, and at least a portion of the solenoid coil 12 is inserted into the solenoid coil guide 120. At least a portion of the solenoid coil guide 120 may be formed of plastic. The solenoid coil guide 120 may be formed by an injection or casting method.

The solenoid coil guide 120 may have a cylindrical shape with open upper and lower surfaces. The solenoid coil guide 120 may be disposed so that the open upper and lower surfaces face the horizontal direction.

The solenoid coil guide 120 may have a settlement groove, and the solenoid coil 12 may be coupled to the solenoid coil guide 120 in a direction-specific manner with respect to the settlement groove. The settlement groove may be recessed in a longitudinal direction of the solenoid coil guide 120 and may extend in a circumferential direction. The settlement groove may be formed in an arc shape whose central angle is less than 180. The settlement groove may be formed by cutting one end of the cylindrical solenoid coil guide 120 through milling or the like. The settlement groove may also be formed by casting or injection using a mold having a shape corresponding to the settlement groove. However, the manufacturing method of the solenoid coil guide 120 and the settlement groove is not limited to this embodiment.

The solenoid valve assembly 100 may include a plurality of solenoid coil guides 120. Each solenoid coil guide 120 corresponds to a different solenoid valve. The solenoid valve assembly 100 according to an embodiment includes a pair of solenoid coil guides 121, 122, a pair of solenoid valves corresponding to each of the pair of solenoid coil guides 121, 122, and a pair of solenoid coils 12a, 12b corresponding to each of the pair of solenoid valves.

The plurality of solenoid coil guides 120 are disposed at the same height. Herein, the height is based on an axial direction of the cylinder 1a. This allows optimization of the disposition space of components other than the shock absorber. In an embodiment, the pair of solenoid coil guides 120 are disposed at the same height.

The plurality of solenoid coil guides 120 may be disposed in parallel with each other. This allows further optimization of the disposition space of components other than the shock absorber. In an embodiment, the pair of solenoid coil guides 120 are disposed in parallel with each other.

The settlement grooves of the plurality of solenoid coil guides 120 may be formed in the same direction. Herein, the settlement grooves being formed in the same direction means that each of the settlement grooves is formed in the same direction from the center of the corresponding solenoid coil guide 120. In an embodiment, one settlement groove is formed on each of a pair of solenoid coil guides 120. The settlement groove may be formed at a lower portion of the solenoid guide 120, but the direction of the settlement groove is not limited to this embodiment.

At least one of the plurality of solenoid coil guides 120 may be coupled with a compression solenoid valve that provides a flowing route of fluid during the compression stroke of the shock absorber. At least one of the plurality of solenoid coil guides 120 may be coupled with a compression solenoid valve that provides a flowing route of fluid during the tension stroke of the shock absorber. In an embodiment, two coil guides 121, 122 are provided, and a compression solenoid valve is coupled to one coil guide 121, and a rebound solenoid valve is coupled to the other coil guide 122.

The solenoid valve may have a cylindrical shape whose outer diameter corresponds to an inner diameter of the solenoid coil guide 120. However, the shape of the solenoid valve of an embodiment of the present disclosure is not limited to this embodiment.

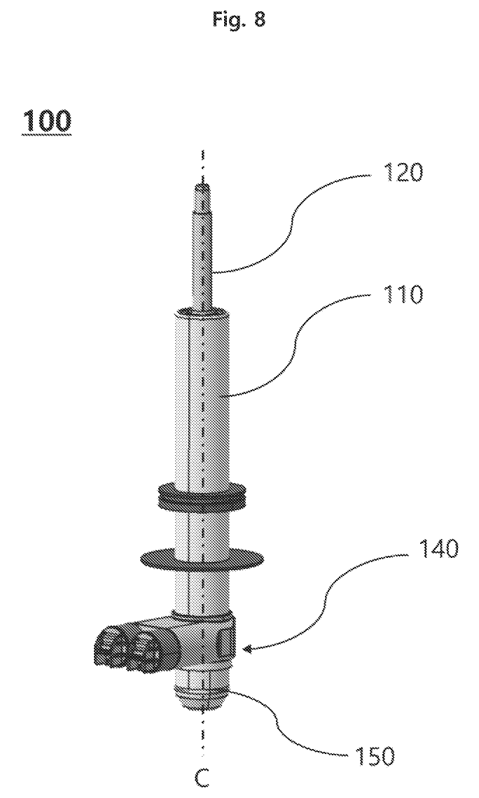

The shock absorber of an embodiment of the present disclosure includes the solenoid valve assembly 100 (FIG. 7) of an embodiment of the present disclosure. Hereinafter, the shock absorber 100 (FIG. 8 and below) according to an embodiment of the present disclosure will be described with reference to FIGS. 8 to 13. In FIGS. 8 to 13, the same reference numerals as those of FIGS. 1 to 7 may refer to subject matters different from those referred to by the duplicated reference numerals of FIGS. 1 to 7. In the description referring to FIGS. 8 to 13, the subject matters referred to by the reference numerals refer to FIGS. 8 to 13, not FIGS. 1 to 7.

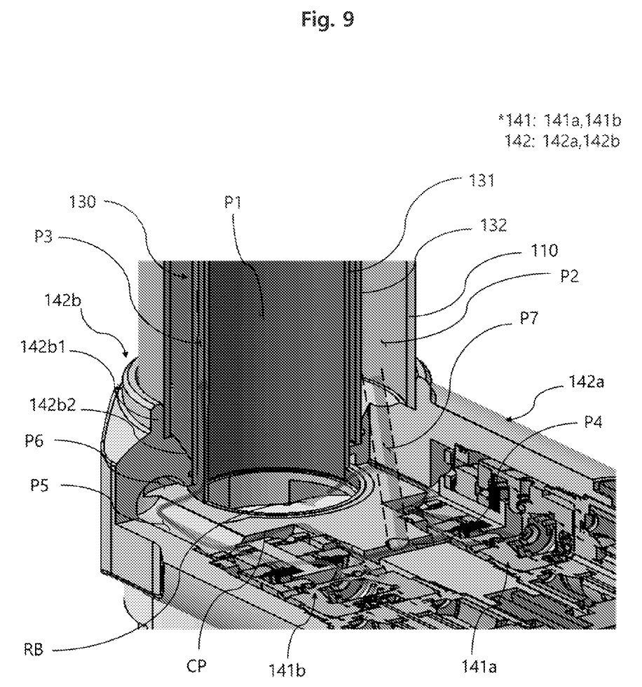

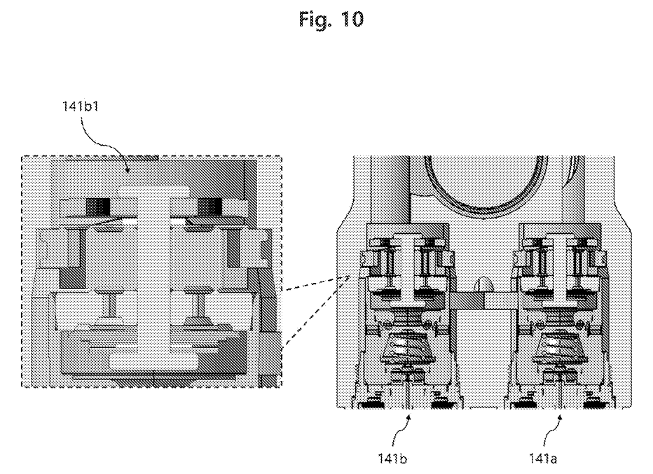

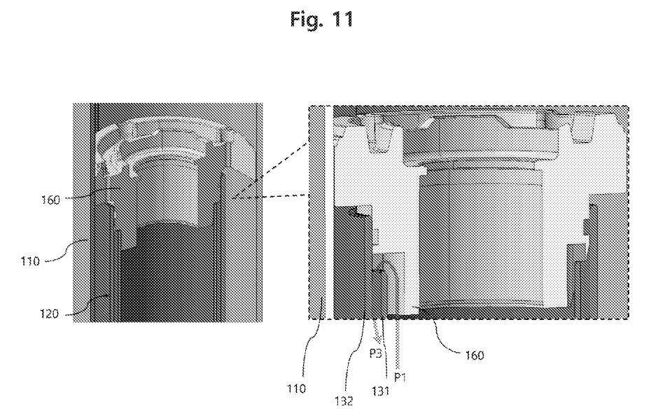

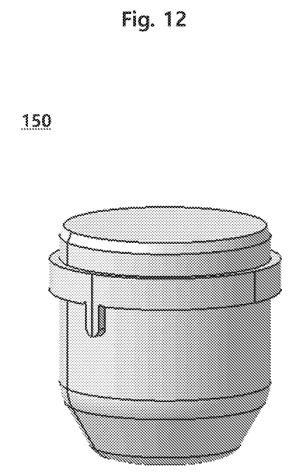

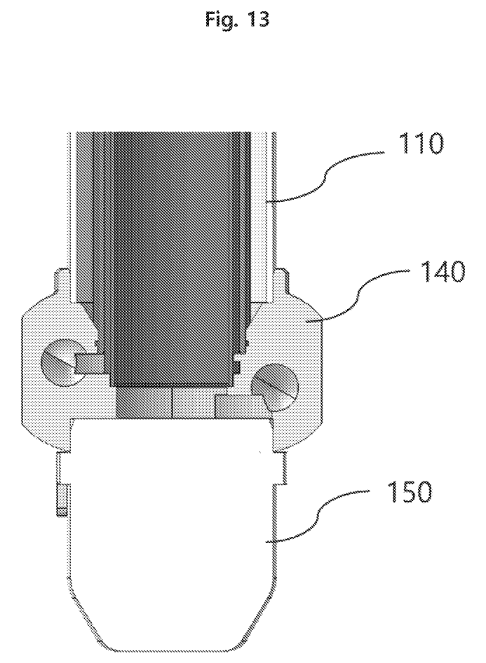

FIG. 8 is a perspective view of a shock absorber according to an embodiment of the present disclosure. FIG. 9 is an exploded perspective view of a shock absorber according to an embodiment of the present disclosure. FIG. 10 is a partial enlarged view of a solenoid valve unit according to an embodiment of the present disclosure. FIG. 11 is an enlarged view of a rod guide according to an embodiment of the present disclosure. FIG. 12 is a perspective view of a cap assembly according to an embodiment of the present disclosure. FIG. 13 is a diagram illustrating a cylinder, a damping force adjustment assembly, and a cap assembly according to an embodiment of the present disclosure. Referring to FIGS. 8 and 9 of an embodiment of the present disclosure, the shock absorber 100 according to an embodiment of the present disclosure includes the cylinder 110, the piston rod 120, the rod guide tube 130, a damping force adjustment assembly 140, a cap assembly 150, and a rod guide 160.

The piston rod 120 reciprocates inside the cylinder 110. The piston rod 120 may slide by being guided by the rod guide 160 inside the cylinder 110. The rod guide 160 may be disposed to guide the fluid inside a rebound chamber, which is the space above a piston, to the space between an inner shell 131 and an outer shell 132 described below (see the arrow in FIG. 11).

The rod guide tube 130 is disposed inside the cylinder 110 and has the inner shell 131 and the outer shell 132. The rod guide 160 may be coupled to an upper portion of the rod guide tube 130. A portion of the rod guide 160 may protrude outside the rod guide tube 130 and be supported by an upper surface of the rod guide tube 130, and another portion of the rod guide 160 may be inserted into the inside of the rod guide 160. The fluid of the shock absorber 100 may flow in the space between the inner shell 131 and the outer shell 132. The inner space of the inner shell 131 may be partitioned into a compression chamber and the rebound chamber by the piston mounted on the piston rod 120.

The damping force adjustment assembly 140 has a mounting block 142 and a solenoid valve unit 141 mounted on the mounting block 142 and disposed on the outside of the cylinder 110. A flow path that is communicated with the flow path inside the cylinder 110 and the solenoid valve unit 141 is formed in the mounting block 142.

The mounting block 142 may include a support block 142a and a coupling unit 142b. The support block 142a supports the solenoid valve unit 141 and has a transmission flow path P5 communicated with the solenoid valve unit 141. The coupling unit 142b is provided integrally with the support block 142a, is connected to the cylinder 110, and has an internal cavity P6 communicated with a flow path P3 between the inner shell 131 and the outer shell 132 and a flow path P1 inside the inner shell. The transmission flow path P5 and the internal cavity P6 are communicated with each other.

The coupling unit 142b may include a flange unit 142b1 that contacts at least a portion of an outer circumferential surface of the cylinder 110. The flange unit 142b1 may prevent fluid from leaking between the cylinder 110 and the mounting block 142. The coupling unit 142b may include an inlet unit 142b2 that divides a flow path between the outer shell 132 and the inner shell 131. At least one lower end of the cylinder 110 and the rod guide tube 130 may be supported upward by the inlet unit 142b2. At least a portion of the internal cavity may extend in a radial direction of the cylinder 110. At least a portion of the transmission flow path may extend in a direction perpendicular to the central axis of the cylinder 110. The coupling unit 142b may have a ring shape that shares a central axis with the cylinder 110.

Referring again to FIG. 7, the solenoid valve assembly 100 includes the coupling unit 110 coupled to the cylinder 1a, the solenoid coil 12, and the solenoid coil guide 120 coupled to the coupling unit 110 and into which at least a portion of the solenoid coil 12 is inserted. The solenoid coil 12 is coupled to the solenoid coil 12 in a direction-specific manner. According to an embodiment of the present disclosure, instead of the solenoid coil 12, the coupling unit 110 is directly coupled to the cylinder 1a, and at least a portion of the solenoid coil guide 120 is formed of plastic, so that changing the direction of the solenoid coil guide 120 requires less cost than in the past.

FIG. 10 is a partial enlarged view of the solenoid valve unit 141 according to an embodiment of the present disclosure. Referring to FIGS. 8 to 10, the solenoid valve unit 141 may include a compression solenoid valve 141a that selectively mutually communicates the flow path P1 inside the inner shell 131 and a flow path P2 between the rod guide tube 130 and the cylinder 110. The compression solenoid valve 141a may be configured to selectively mutually communicate the compression chamber, which is partitioned by the inner shell 131 and the piston, and the flow path P2 between the rod guide tube 130 and the cylinder 110.

The compression solenoid valve 141a may include a compression check valve 141a1 that allows the flow of fluid from the flow path P1 inside the inner shell 131 to the flow path P2 between the rod guide tube 130 and the cylinder 110, and restricts the flow of fluid from the flow path P2 between the rod guide tube 130 and the cylinder 110 to the flow path P1 inside the inner shell 131.

The solenoid valve unit 141 may include a rebound solenoid valve 141b that selectively mutually communicate the flow path P3 between the inner shell 131 and the outer shell 132, and the flow path P1 inside the inner shell 131.

The rebound solenoid valve 141b may include a rebound check valve 141b1 that allows the flow of fluid from the flow path P3 between the inner shell 131 and the outer shell 132 to the flow path P1 inside the inner shell 131, and restricts the flow of fluid from the flow path P1 inside the inner shell 131 to the flow path P3 between the inner shell 131 and the outer shell 132.

The compression solenoid valve 141a and the rebound solenoid valve 141b may be disposed in a direction perpendicular to the central axis (C) of the cylinder 110. The compression solenoid valve 141a and the rebound solenoid valve 141b may be disposed in parallel with each other. The compression solenoid valve 141a and the rebound solenoid valve 141b may be disposed on the same plane.

The damping force adjustment assembly 140 may have a connection path P4 that mutually communicates the compression solenoid valve 141a and the rebound solenoid valve 141b, and a reservoir communication hole P7 that is connected to a flow path between the rod guide tube 130 and the cylinder 110 from the connection path P4. At least a portion of the connecting path P4 and the reservoir communication hole P7 may be formed in the support block 142a.

The cap assembly 150 is coupled to the damping force adjustment assembly 140 to partition the interior of the shock absorber 100. In an embodiment, the cylinder 110 is mounted on an upper side of the damping force adjustment assembly 140, and the cap assembly 150 is mounted on a lower side of the damping force adjustment assembly 140. At least a portion of the mounting block 142 may be in contact with an outer circumferential surface of the cap assembly 150.

Referring again to CP of FIG. 9, during the compression stroke, the fluid sequentially flows into the connection path P4 through the interior of the inner shell 131 (P1, specifically, the compression chamber), the internal cavity P6, the transmission flow path P5, and the compression solenoid valve 141a, and the fluid flowing into the connection path P4 flows into a space P2 between the cylinder 110 and the rod guide tube 130 through the reservoir communication hole P7 or flows into a space P3 between the inner shell 131 and the outer shell 132.

Referring to RB of FIG. 9, during the rebound stroke, the fluid may sequentially flow into the compression chamber through the interior of the inner shell 131 (P1, specifically, the rebound chamber), the space P3 between the inner shell 131 and the outer shell 132, the internal cavity P6, the transmission path P5, the rebound solenoid valve 141b, and the connection path P4.

In an embodiment of the present disclosure, it may be understood that the space below the piston within the inner shell 131 corresponds to the compression chamber, the space above the piston within the inner shell 131 corresponds to the rebound chamber, the space P3 between the inner shell 131 and the outer shell 132 corresponds to a separation flow path, and the space P2 between the rod guide tube 130 and the cylinder 110 corresponds to the reservoir chamber.

The vehicle of an embodiment of the present disclosure includes the vehicle having the solenoid valve of an embodiment of the present disclosure.

Hereinbefore, although the technical ideas of the present disclosure have been disclosed for illustrative purposes, a person having ordinary skill in the art to which the present disclosure pertains will appreciate that various modifications and variations are possible, without departing from the spirit and essential characteristics of the present disclosure. Therefore, the embodiments of the present disclosure are disclosed only for illustrative purposes and should not be construed as limiting the technical ideas of the present disclosure. The scope of protection of the present disclosure should be determined on the basis of the descriptions in the appended claims, and all technical ideas within the scope of equivalents thereof should be construed as being included in the scope of right of the present disclosure.

### Detailed Description of Main Elements

1a: Cylinder

100: Solenoid valve assembly

110: Coupling unit

120: Solenoid coil guide

12: Solenoid coil

What is claimed is:

1. A solenoid valve assembly mounted on a cylinder of a shock absorber, the solenoid valve assembly comprising:
a coupling unit coupled to the cylinder;
a solenoid coil; and
a solenoid coil guide coupled to the coupling unit and into which at least a portion of the solenoid coil is inserted,
wherein the solenoid coil is coupled to the solenoid coil guide in a direction-specific manner, and at least a portion of the solenoid coil guide is formed of plastic.

2. The solenoid valve assembly of claim 1, wherein the solenoid coil guide is formed by an injection or casting method.

3. The solenoid valve assembly of claim 1, wherein the coupling unit has a ring-shaped insertion unit that surrounds an outer circumferential surface of the cylinder.

4. The solenoid valve assembly of claim 1, wherein the solenoid coil guide has a cylindrical shape with open upper and lower surfaces.

5. The solenoid valve assembly of claim 4, wherein:
the solenoid coil guide has a longitudinally recessed and circumferentially extended settlement groove formed therein; and
the solenoid coil is coupled to the solenoid coil guide with respect to the settlement groove in the direction-specific manner.

6. The solenoid valve assembly of claim 1, wherein:
the coupling unit has at least one flat surface; and
the coil guide is coupled to the flat surface.

7. The solenoid valve assembly of claim 1, wherein the flat surface is disposed on an outer side of the cylinder in a radial direction thereof.

8. The solenoid valve assembly of claim 7, wherein the flat surface is disposed perpendicular to the radial direction of the cylinder.

9. The solenoid valve assembly of claim 8, wherein a distance from the flat surface to a distal end of the solenoid coil guide is shorter than a distance from an outer circumferential surface of the cylinder to the flat surface.

10. The solenoid valve assembly of claim 1, wherein the solenoid coil guide comprises a plurality of solenoid coil guides.

11. The solenoid valve assembly of claim 10, wherein the plurality of solenoid coil guides are positioned at a same height.

12. The solenoid valve assembly of claim 11, wherein the plurality of solenoid coil guides are disposed to be parallel with one another.

13. The solenoid valve assembly of claim 5, wherein:
the solenoid coil guide comprises a plurality of solenoid coil guides and the settlement groove comprises a plurality of settlement grooves, each of the plurality of settlement grooves being provided for one of the plurality of solenoid coil guides; and
the plurality of settlement grooves are formed in a same direction.

14. The solenoid valve assembly of claim 13, wherein the settlement groove is formed at a lower portion of the solenoid coil guide.

15. The solenoid valve assembly of claim 10, wherein at least one of the plurality of solenoid coil guides is coupled with a compression solenoid valve that provides a flowing route of fluid during a compression stroke of the shock absorber.

16. The solenoid valve assembly of claim 10, wherein at least one of the plurality of solenoid coil guides is coupled with a rebound solenoid valve that provides a flowing route of fluid during a tension stroke of the shock absorber.

17. The solenoid valve assembly of claim 1, wherein a flow path is formed inside the coupling unit to communicate the solenoid valve assembly and an inside of the cylinder.

18. The solenoid valve assembly of claim 1, wherein a cross-section of the coupling unit, which is perpendicular to a radial direction, is in a stadium shape.

19. A shock absorber comprising the solenoid valve assembly according to claim 1.

20. A vehicle comprising a shock absorber having the solenoid valve assembly according to claim 1.
